(19) United States
(12) Patent Application Publication
(10) Pub. No.: US 2002/0026375 A1
(43) Pub. Date: Feb. 28, 2002

(54) Communication method, and network device or system for purchasing new item or picking-up of old items

(76) Inventors: Keiichi Tomitsuka, Kanagawa (JP); Mizuko Matsumoto, Kanagawa (JP)

Correspondence Address: ROBIN BLECKER & DALEY, 2ND FLOOR, 330 MADISON AVENUE, NEW YORK, NY, 10017, US

(21) Appl. No.: 09/900,388

(22) Filed: Jul. 6, 2001

(30) Foreign Application Priority Data
Jul. 11, 2000 (JP) 210145/2000

(51) Int. Cl. G06F 17/60

(52) U.S. Cl. 705/26; 705/1; 705/7

(57) ABSTRACT

A communication method according to the present invention includes the steps of: specifying request for purchase or picking-up of goods; inputting a requester's address where the purchase or picking-up of goods is performed; and communicating the specified request contents and address to the outside, via a network to instruct that purchase or picking-up of goods be performed at the requester's address.

### BACKGROUND OF THE INVENTION

1. Field of the Invention

This invention relates to a network communication technique, and particularly to the network communication technique for purchasing a new item or picking up items to be recycled.

2. Related Background Art

Unnecessary goods resulting from purchasing for replacement and other reasons are often discarded as waste.

However, with a trend toward recycling, it is predicted that not only house electrical appliances but also OA equipment such as a printer must be collected in the future. This collection of house electrical appliances and OA equipment will be a heavy burden on collectors and users, therefore, an efficient collecting method is required.

In addition, efficient collection of goods promotes recycling, resulting that manufacturers can use recycled articles and resources can be environmentally, effectively utilized.

### SUMMARY OF THE INVENTION

It is therefore an object of the present invention to provide a network device or system, a communication method, and a storage medium for efficiently purchasing a new item and picking up an item to be recycled.

According to one aspect of the present invention, it is provided that a network system comprising:

request specifying means for specifying request for purchase or picking-up of goods;

address input means to input a requester's address where the purchase or picking-up of goods is performed; and

communication means for communicating the request contents specified with the request specifying means and the address inputted with the address input means to the outside via a network to instruct that purchase or picking-up of goods be performed at the requester's address.

According to another aspect of the present invention, it is provided that a network system comprising:

input means for inputting request information for purchase or picking-up of goods and a requester's address information where the purchase or picking-up of goods is performed via a network; and

transmitting means for transmitting the request and address information to a transportation company via a network in order to request the purchase or picking-up of goods at the requester's address.

According to another aspect of the present invention, it is provided that a network system comprising:

input means for inputting request information for purchase or picking-up of goods and a requester's address information at which the purchase or picking-up of goods is performed;

transmission means for sending the request and address information via network in order to request from a transportation company purchase or picking-up of goods at the requester's address; and

completion information acquiring means for acquiring information that the transportation company completed picking up goods, via a network.

According to another aspect of the present invention, it is provided that a network system having first and second network devices connected with each other via a network comprising,

a first network device comprising:

request specifying means for specifying the request for purchase or picking-up of goods;

address input means for inputting a requester's address where the purchase or picking-up of goods is performed; and

communication means for notifying the second network device of the request contents specified with the request specifying means and the address inputted with the address input means for instructing purchase or picking-up of goods to be performed at the requester's address, and

a second network device comprising:

input means for inputting the request contents of purchase or picking-up of goods and the requester's address where the purchase or picking-up of goods is performed from the first network device via a network; and

transmitting means for sending the request contents and address to a transportation company via a network in order to request from the transportation company purchase or picking-up of goods at the requester's address.

According to another aspect of the present invention, it is provided that a network system having first and second network devices connected with each other via a network, wherein the first network device comprises:

input means for inputting the request contents of purchase or picking-up of goods and the requester's address where the purchase or picking-up of goods is performed via a network;

transmission means for sending the request and address information to the second network device via network in order to request from a transportation company purchase or picking-up of goods at the requester's address; and

completion information acquiring means for acquiring information that the transportation company completed picking up goods, from the network device via a network, and

the second network device comprises:

notification means for notifying the first network device of information that picking-up of goods is completed, via a network after the transportation company performs picking-up of goods.

According to another aspect of the present invention, it is provided that a network system having first, second and third network devices connected with one other via a network, wherein the first network device comprises:

request specifying means for specifying request of purchase or picking-up of goods;

address input means for inputting a requester's address where the purchase or picking-up of goods is performed; and

communication means for informing the second network device of the request contents specified with the request specifying means and the address inputted with the address input means via a network to instruct that purchase or picking-up of goods be performed at the requester's address, and

the second network device comprises:

input means for inputting the request contents of purchase or picking-up of goods and address of a requester where the purchase or picking-up of goods is performed, via a network;

transmitting means for transmitting the request contents and address to the third network device via a network in order to request from the transportation company purchase or picking-up of goods at the requester's address; and

completion information acquiring means for acquiring information that the transportation company completed picking up goods, from the third network device via a network, and

the third network device comprises:

notification means for notifying the second network device of the information that picking-up of goods is completed, via a network after the transportation company performs picking-up of goods.

According to another aspect of the present invention, it is provided that a communication method comprising the steps of:

(a) specifying request for purchase or picking-up of goods;

(b) inputting a requester's address where the purchase or picking-up of goods is performed; and

(c) communicating the specified request contents and address to the outside, via a network to instruct that purchase or picking-up of goods be performed at the requester's address.

According to another aspect of the present invention, it is provided that a communication method comprising the steps of:

(a) inputting request information for purchase or picking-up of goods and a requester's address information at which the purchase or picking-up of goods is performed, via a network; and

(b) transmitting the request and address information to a transportation company via a network in order to request the transportation company to perform purchase or picking-up of goods at the requester's address.

According to another aspect of the present invention, it is provided that a communication method comprising the steps of:

(a) inputting request information for purchase or picking-up of goods and a requester's address information at which the purchase or picking-up of goods is performed, via a network;

(b) transmitting the request and address information to a transportation company via a network in order to request the transportation company to perform purchase or picking-up of goods at the requester's address; and

(c) acquiring information that the transportation company completed picking-up of goods, via a network.

According to another aspect of the present invention, it is provided that a computer-readable storage medium having programs recorded on it to make a computer execute:

(a) a procedure to specify request for purchase or picking-up of goods;

(b) a procedure to input a requester's address where the purchase or picking-up of goods is performed; and

(c) a procedure to communicate the specified request contents and address to the outside, via a network to instruct that purchase or picking-up of goods be performed at the requester's address.

According to another aspect of the present invention, it is provided that a computer-readable storage medium having programs recorded on it to make a computer execute:

(a) a procedure of inputting request information for purchase or picking-up of goods and a requester's address information at which the purchase or picking-up of goods is performed, via a network; and

(b) a procedure of transmitting the request and address information to a transportation company via a network in order to request the transportation company to perform purchase or picking-up of goods at the requester's address.

According to another aspect of the present invention, it is provided that a computer-readable storage medium having programs recorded on it to make a computer execute:

(a) a procedure of inputting request information for purchase or picking-up of goods and a requester's address information at which the purchase or picking-up of goods is performed, via a network;

(b) a procedure of transmitting the request and address information to a transportation company via a network in order to request the transportation company to perform purchase or picking-up of goods at the requester's address; and

(c) a procedure of acquiring the information that the transportation company completed picking-up of goods, via a network.

### BRIEF DESCRIPTION OF THE DRAWINGS

FIG. 1 shows a block diagram showing a network system structure according to the present invention;

FIG. 2 shows a block diagram showing a computer structure;

FIG. 3 shows a flowchart showing the process performed by the network system;

FIG. 4 shows a user request view;

FIG. 5 shows items of the database; and

FIG. 6 shows an inventory management label.

### DETAILED DESCRIPTION OF THE PREFERRED EMBODIMENTS

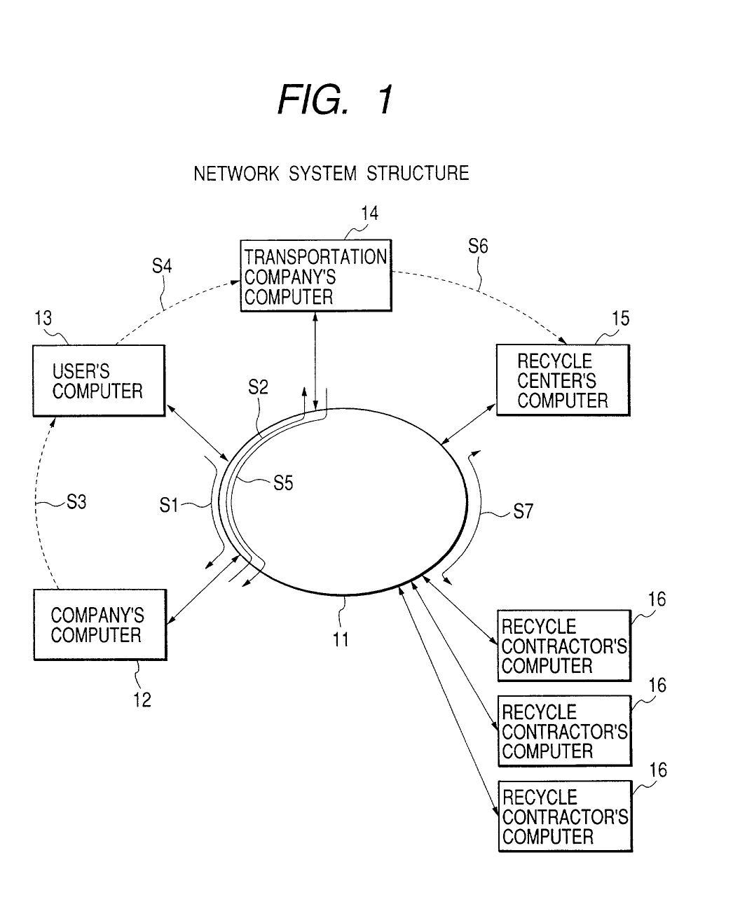

FIG. 1 shows a block diagram showing the network system structure according to the present invention. To a network 11, such as the Internet, are connected a company's computer 12, a user's computer 13, a transportation company's computer 14, a recycling center computer 15, and recycling contractor's computers 16.

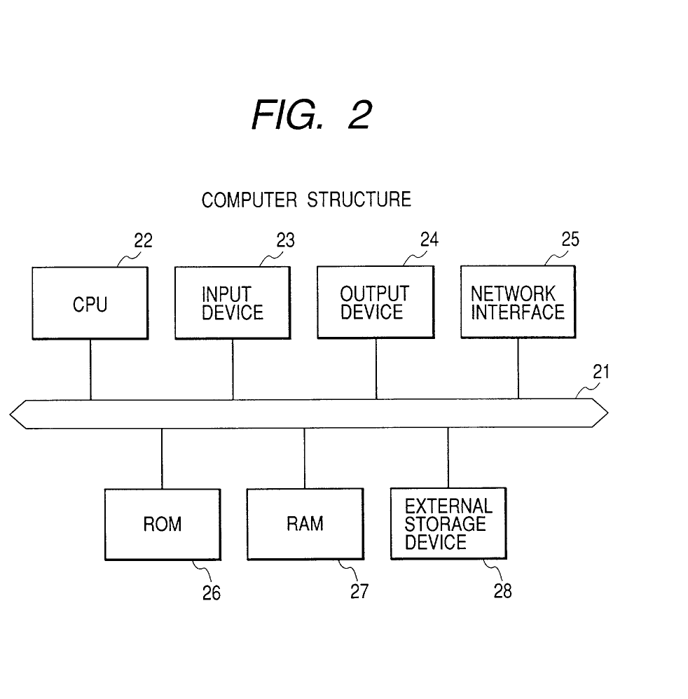

FIG. 2 shows the structure of each of the computers 12 to 16. The computers 12 to 16 are, for example, a personal computer or a general-purpose computer, having the same structure. To a bus 21 are coupled a central processing unit (CPU) 22, an input device 23, an output device 24, a network interface 25, ROM 26, RAM 27, and an external storage device 28.

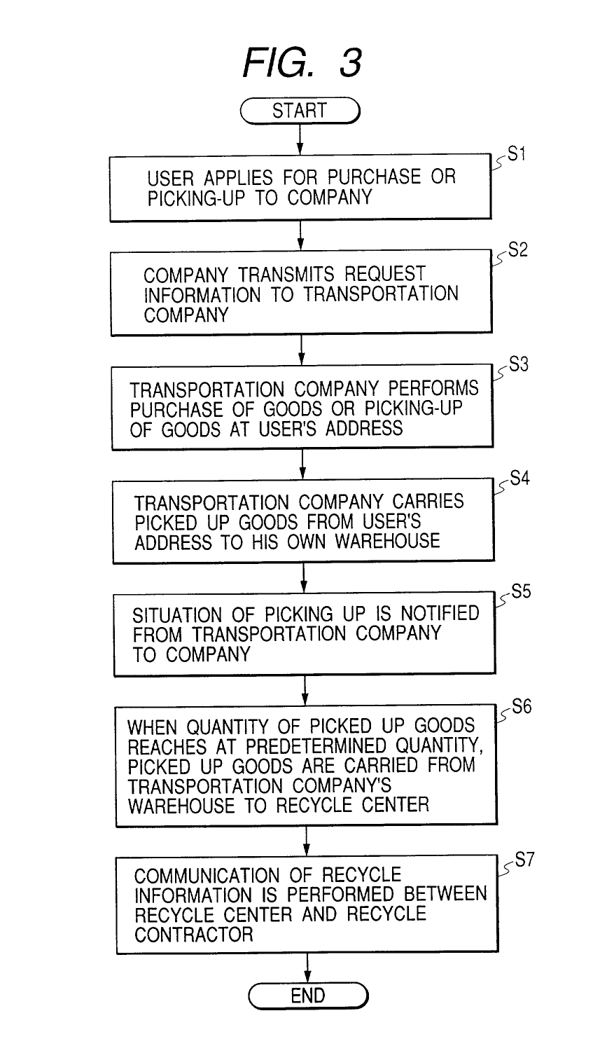

The CPU 22, which performs date processing or computing, and also controls each structure element connected via the bus 21, executes processes in the flowchart shown in FIG. 3 as will be described later.

The ROM 26 stores control procedures (computer programs) of the CPU 22 in advance. When the CPU 22 executes the computer programs, processes as such as input and output of data, and sending and receiving of data can be carried out. The RAM 27 is employed as a work memory for input and output of data, and sending and receiving of date, and as a temporal memory for controlling each structure element.

The external storage device 28 is, for example, a hard disc storage device or CD-ROM, and does not lose memory contents if power is turned off. The network interface 25 is an interface, which connects each of the computers 12 to 16 shown in FIG. 1 to the network 11. The input device 23 includes, for example, a keyboard and a mouse, performing various specification and input of data. The output device 24 includes a display and a printer, displaying and printing screens.

This invention comprises means for providing computer programs to a computer, such as storage media storing the computer programs. The storage device, which stores the computer programs, includes a floppy disk, a hard disc, an optical disc, an optomagnetic disc, CD-ROM, a magnetic tape, a non-volatile memory card, and ROM. The computer programs on a storage medium are copied into the RAM 27, and then executed.

FIG. 3 shows a flowchart for the process of a network system according to this embodiment. Each process will be described referring to FIGS. 1 and 3. In FIG. 1, the solid line arrow shows on-line flow of information (data) via the network 11, and the dotted line arrow shows off-line flow of goods, corresponding to each of the steps S1 to S7 in FIG. 3.

In step S1, a user makes request for purchase or picking-up of goods from a company. Specifically, the user's computer 13 accesses the homepage of the company's computer 12 via the network 11.

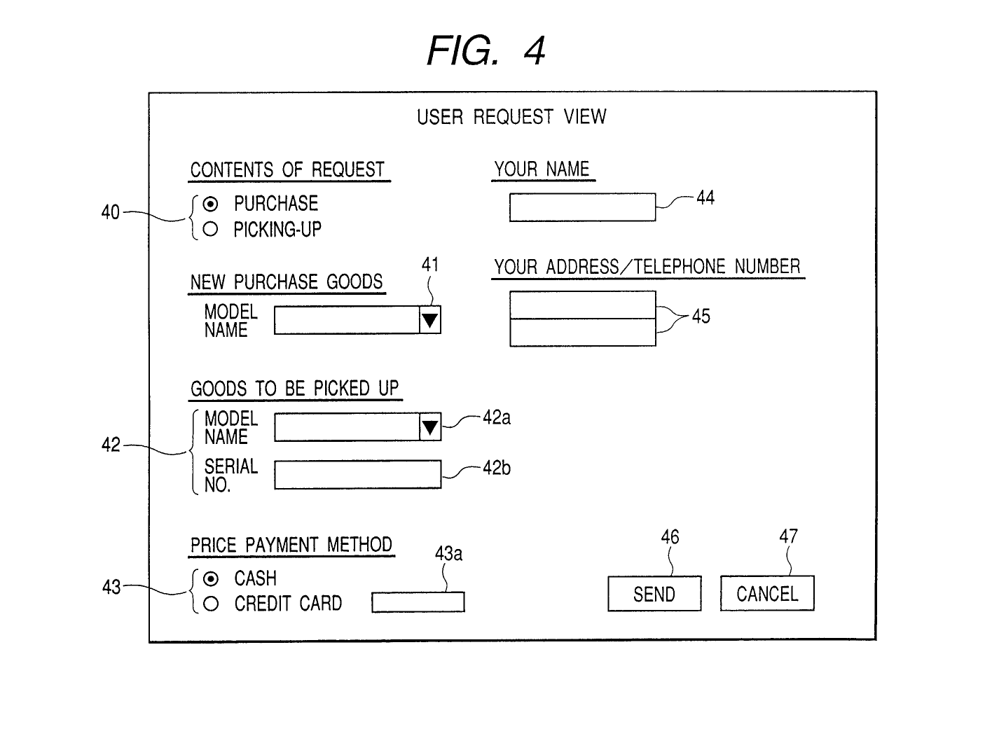

Then, a user request view shown in FIG. 4 is displayed on the user's computer 13. The user inputs the following items: As request contents 40, either purchasing or picking-up can be selected. The “purchase” means that an user purchases new goods or items, and hands over unnecessary goods at the same time. The “picking-up” means that unnecessary goods or items are handed over. The goods include OA equipment and house electric appliances.

If selected purchase, the user inputs new purchase goods (item) 41 and picking-up goods (item) 42. If selected picking-up, the user inputs the picking-up goods 42. The new purchase goods 41 can be selected from the model names of OA equipment and house electric appliances displayed in a menu item. For picking-up goods 42, the user inputs model name 42a and serial No. 42b of picking-up goods.

As payment method 43, cash or credit card can be selected. In case of picking-up, picking-up fees (recycling fees) for carrying picking-up goods must be paid. In case of purchase, piece of new purchase goods must be paid in addition to picking-up fee. If selected credit card as payment method 43, a credit number is inputted in input area 43a.

In your name 44, the name of the requester (user) is input. In your address/telephone number 45, the address and telephone number of the requester is input. Alternatively, the E-mail address of the requester may be input. At the requester's address 45, a transportation company performs purchasing or picking-up of goods.

Finally, when clicking the send button 46, the above-described request information is transmitted from the user's computer 13 to the company's computer 12. When clicking cancel button 47, the transmission is canceled, and then the user request view is exited.

In step S2 shown in FIG. 3, the company's computer 12 transmits the above received request information to the transportation company's computer 14. The company's computer 12 confirms the stock of new purchase goods and may transmit the information on the date of purchasing or picking-up to the user's computer 13 via E-mail.

In step S3, the transportation company performs purchasing or picking-up of goods at the user's address. Specifically, when the user specifies picking-up goods, the transportation company carries the picked up goods from the user's address. Subsequently, the user pays the picking-up fees to the transportation company, if the user selects cash payment.

On the other hand, when the user selects purchase, the transportation company carries new purchase goods from the company to the user's address, and then delivers the goods to the user, picking up the picked up goods. If the user selects cash payment, the user pays the picking-up fee and the price of new purchase goods to the transportation company.

In step S4, the transportation company attaches a recycling ticket and a delivery slip to the picked up goods, and carries them from the user's address (the user's computer 13) to his own warehouse (the transportation company's computer 14). The transportation company may issue the above-mentioned recycling ticket. Alternatively, the company may issue a recycling ticket, and then hand it over to the transportation company. The method, in which the user pays picking-up fees at a post office and purchases a recycling ticket, may be used, but purchasing the ticket at a post office is troublesome. Therefore, attaching a recycling ticket to picked up goods by the transportation company can reduce users' burden, resulting in promotion of recycling. The above-mentioned delivery slip may also be printed with a printer, using the request information received by the transportation company's computer 14.

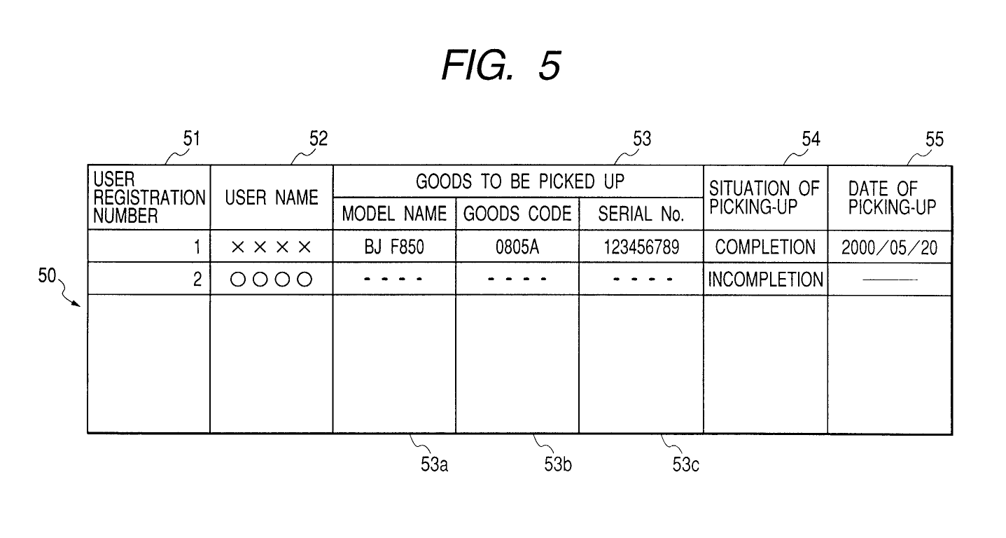

In step S5, the situation of picking up is communicated from the transportation company's computer 14 to the company's computer 12. Specifically, the database 50 shown in FIG. 5 is created in the transportation company's computer 14 according to the request information received in step S2. Items of the database 50 include user (requester) registration number 51, user name 52, picking-up goods 53, picking-up situation 54, and picking-up date 55. The picking-up goods 53 has a model name 53a, goods code 53b, and serial number (serial No.) 53c.

The user registration number 51 is a number assigned to a new user. Once registered, inputting the user registration number 51 on the user request view shown in FIG. 4 allows the user to make request without inputting the address/telephone number 45. This user registration number 51 is assigned to the company's computer 12 as well as the transportation company's computer 14.

The items 52, 53a, and 53c of the database are the same as the above-described request information. The goods code 53b is given by the company's computer 12 according to the model name 53a, and transmitted with the above-mentioned request information from the company's computer 12 to the transportation company's computer 14.

The picking up situation 54 becomes completed if the picked up goods arrive at the transportation company, and becomes uncompleted if they do not arrive. In the picking-up date 55, the date on which the transportation company picked up goods is inputted.

This database 50 may be sent to the company's computer 12 by the transportation company's computer 14. Alternatively, the company's computer 12 may directly read the database 50 in the transportation company's computer 14. The company's computer 12 can determine whether or not purchase or picking-up is completed by referring to the database 50. Once the company's computer 12 determines the completion of purchase or picking-up, settlement with a credit card is performed if the user selects credit card payment.

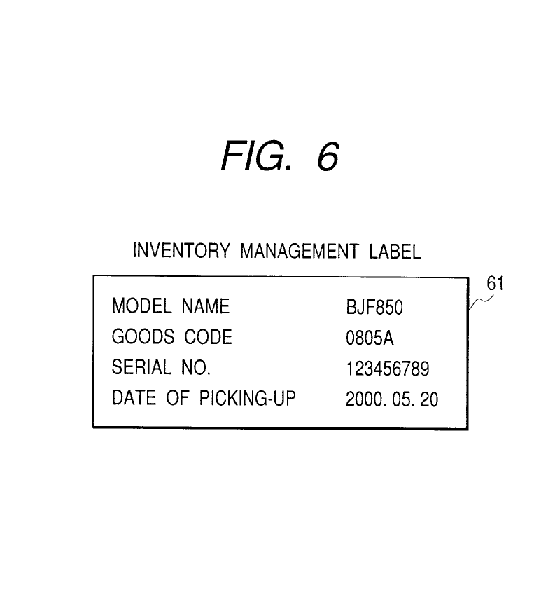

When the above-mentioned picked up goods arrive at the transportation company's warehouse from the user's address, the picked up goods are attached with an inventory management label 61 shown in FIG. 6. The transportation company's computer 14 prints the inventory management label 61 based on the contents of the above-mentioned database 50. The inventory management label 61 contains model name, goods code, serial No., and picking-up date. Picked up goods are managed in the warehouse until the specified amounts of picked up goods are stored in the warehouse.

In step 6, for efficient delivery, when the number of picked up goods reaches the specified quantity, the transportation company carries them from his own warehouse (computer 14) to the recycling center (computer 15).

In step 7, recycling information is sent and received between the recycling center's computer 15 and the recycling contractor's computer 16. Thus, the recycling center disassemble picked up goods into parts, and each group of parts is picked up by each recycling contractor 16. The parts are employed for new products.

Moreover, the recycling operation, such as disassembling of picked up goods, is not performed only at the recycling center. Since picked up goods are stored until the number of them reaches the specified quantity, staff of the recycling center may perform recycling operation at the transportation company's warehouse. Alternatively, the transportation company himself may perform recycling operation at his warehouse.

As described above, the request for purchasing or picking-up of goods can be carried out by inputting the specified item on the homepage via a network, and the user can easily perform purchase or picking-up of goods at his address. Then, the transportation company attaches recycling ticket to picked up goods, and carries them into his warehouse. After picking up, the transportation company notifies the company of the completion of picking-up. With the notification, the company admits that purchase or picking-up of goods is completed.

In the above-mentioned process, purchase or picking-up of goods can be carried out without users' labor, efficiently using an on-line network. In addition, reducing users' labor leads to promotion of recycling and environmentally effective usage of resources.

Moreover, in case of purchasing, the example described above has a great advantage in terms of efficient materials flow because a return route after delivering new goods can be used to deliver picked up goods.

This network system can promote not only picking up but also purchase. Since this purchase promotes the sale of new goods, companies obtain a great advantage. If a user request purchase, the company can give privileges, such as servicing ink or paper for printers free of charge and discounting picking-up fees for recycling tickets, to the user. Alternatively, the privileges may be given to users after the completion of purchase or picking-up is confirmed on the database 50 (FIG. 5).

In the user request view shown in FIG. 4, requesting users to answer questionnaires about usage year of goods is useful because hints on new product development can be obtained, leading to acquisition of new users. Also, picked up goods may be directly delivered from the transportation company's warehouse to the recycling contractor, instead of delivering them from the transportation company's warehouse to the recycling center.

The above-described embodiments are only some specific examples when practicing the present invention, therefore, the technical scope of the present invention must not be constructed to be limited. Thus, the present invention can be practiced in various forms without deviating from the technical idea or the principal features.

According to the embodiments described above, purchase or picking-up of goods can be performed at a requester s address. This request is executed via a network, therefore, the user can make request easily, allowing promotion of recycling and effective utilization of resources.

What is claimed is:

1. A network system comprising:
request specifying means for specifying request for purchase or picking-up of goods;
address input means for inputting a requester's address where said purchase or picking-up of goods is performed; and
communication means for communicating the request contents specified with said request specifying means and the address inputted with said address input means to the outside via a network to instruct that purchase or picking-up of goods be performed at the requester's address.

2. The network system as described in claim 1, further comprising picked up goods information input means to input the information on picked up goods when performing purchase or picking-up of goods, said communication means communicating said picked up goods information to the outside.

3. The network system as described in claim 1, further comprising new purchase goods information input means to input the information on new purchase goods when specified purchase of goods with said request specifying means, said communication means communicating said new purchase goods information to the outside.

4. A network system comprising:
input means for inputting request information for purchase or picking-up of goods and a requester's address information where said purchase or picking-up of goods is performed via a network; and
transmitting means for transmitting said request and address information to a transportation company via a network in order to request purchase or picking-up of goods at said requester's address.

5. The network system as described in claim 4, wherein said input means inputs picked up goods information when performing purchase or picking-up of goods, and said transmitting means sends said picked up goods information to the transportation company.

6. The network system as described in claim 4, wherein said input means inputs new purchase goods information when selected said purchase of goods, and said transmitting means sends said new purchase goods information to the transportation company.

7. The network system as described in claim 4, further comprising completion information acquiring means to acquire information on completion of picking-up of goods from the transportation company via a network.

8. A network system comprising:
input means for inputting request information for purchase or picking-up of goods and a requester's address information at which said purchase or picking-up of goods is performed;
transmission means for sending said request and address information via network in order to request from a transportation company purchase or picking-up of goods at said requester's address; and
completion information acquiring means for acquiring information that the transportation company completed picking up goods, via a network.

9. A network system having first and second network devices connected with each other via a network comprising,
a first network device comprising:
request specifying means for specifying the request for purchase or picking-up of goods;
address input means for inputting a requester's address where said purchase or picking-up of goods is performed; and
communication means for notifying said second network device of the request contents specified with said request specifying means and the address inputted with said address input means for instructing purchase or picking-up of goods to be performed at the requester's address, and
a second network device comprising:
input means for inputting the request contents of purchase or picking-up of goods and the requester's address where said purchase or picking-up of goods is performed from said first network device via a network; and
transmitting means for sending said request contents and address to a transportation company via a network in order to request from the transportation company purchase or picking-up of goods at said requester's address.

10. The second network device as described in claim 9, further comprising completion information acquiring means to acquire the information that picking-up of goods is completed from the transportation company via a network.

11. A network system having first and second network devices connected with each other via a network, wherein said first network device comprises:
input means for inputting the request contents of purchase or picking-up of goods and the requester's address where said purchase or picking-up of goods is performed via a network;
transmission means for sending said request and address information to said second network device via network in order to request from a transportation company purchase or picking-up of goods at said requester's address; and
completion information acquiring means for acquiring information that the transportation company completed picking up goods, from said network device via a network, and
said second network device comprises:
notification means for notifying said first network device of information that picking-up of goods is completed, via a network after the transportation company performs picking-up of goods.

12. The network system as described in claim 11, wherein said second network device further comprises sending instruction means for instructing sending the picked up goods to be sent if the number of the picked up goods to be sent reach a specified quantity.

13. A network system having first, second and third network devices connected with one other via a network, wherein said first network device comprises:
request specifying means for specifying request of purchase or picking-up of goods;
address input means for inputting a requester's address where said purchase or picking-up of goods is performed; and
communication means for informing said second network device of the request contents specified with said request specifying means and the address inputted with said address input means via a network to instruct that purchase or picking,-up of goods be performed at the requester's address, and
said second network device comprises:
input means for inputting the request contents of purchase or picking-up of goods and address of a requester where said purchase or picking-up of goods is performed, via a network;
transmitting means for transmitting said request contents and address to said third network device via a network in order to request from the transportation company purchase or picking-up of goods at said requester's address; and
completion information acquiring means for acquiring information that the transportation company completed picking up goods, from said third network device via a network, and
said third network device comprises:
notification means for notifying said second network device of the information that picking-up of goods is completed, via a network after the transportation company performs picking-up of goods.

14. The network system as described in claim 13, wherein said third network device comprises sending instruction means for instructing the picked up goods to be sent if the number of the picked up goods reach a specified quantity.

15. A communication method comprising the steps of:
(a) specifying request for purchase or picking-up of goods;
(b) inputting a requester's address where said purchase or picking-up of goods is performed; and
(c) communicating said specified request contents and address to the outside, via a network to instruct that purchase or picking-up of goods be performed at the requester's address.

16. A communication method comprising the steps of:
(a) inputting request information for purchase or picking-up of goods and a requester's address information at which said purchase or picking-up of goods is performed, via a network; and
(b) transmitting said request and address information to a transportation company via a network in order to request the transportation company to perform purchase or picking-up of goods at said requester's address.

17. A communication method comprising the steps of:
(a) inputting request information for purchase or picking-up of goods and a requester's address information at which said purchase or picking-up of goods is performed, via a network;
(b) transmitting said request and address information to a transportation company via a network in order to request the transportation company to perform purchase or picking-up of goods at said requester's address; and
(c) acquiring information that the transportation company completed picking-up of goods, via a network.

18. A computer-readable storage medium having programs recorded on it to make a computer execute:
(a) a procedure to specify request for purchase or picking-up of goods;
(b) a procedure to input a requester's address where said purchase or picking-up of goods is performed; and
(c) a procedure to communicate said specified request contents and address to the outside, via a network to instruct that purchase or picking-up of goods be performed at the requester's address.

19. A computer-readable storage medium having programs recorded on it to make a computer execute:
(a) a procedure of inputting request information for purchase or picking-up of goods and a requester's address information at which said purchase or picking-up of goods is performed, via a network; and
(b) a procedure of transmitting said request and address information to a transportation company via a network in order to request the transportation company to perform purchase or picking-up of goods at said requester's address.

20. A computer-readable storage medium having programs recorded on it to make a computer execute:
(a) a procedure of inputting request information for purchase or picking-up of goods and a requester's address information at which said purchase or picking-up of goods is performed, via a network;
(b) a procedure of transmitting said request and address information to a transportation company via a network in order to request the transportation company to perform purchase or picking-up of goods at said requester's address; and
(c) a procedure of acquiring the information that the transportation company completed picking-up of goods, via a network.
